(19) United States
(12) Patent Application Publication
(10) Pub. No.: US 2002/0073172 A1
(43) Pub. Date: Jun. 13, 2002

(54) Method and apparatus for storing content within a video on demand environment

(75) Inventors: James B. Armstrong, Princeton, NJ (US); Michael E. Leimer, Fremont, CA (US)

Correspondence Address: MOSER, PATTERSON & SHERIDAN L.L.P., 595 SHREWSBURY AVE, FIRST FLOOR, SHREWSBURY, NJ, 07702, US

(73) Assignee: DIVA SYSTEMS CORP.

(21) Appl. No.: 09/733,407

(22) Filed: Dec. 8, 2000

Related U.S. Application Data
(60) Provisional application No. 60/170,138, filed on Dec. 10, 1999.

(51) Int. Cl. G06F 15/173; G06F 15/16

(52) U.S. Cl. 709/219; 709/225

(57) ABSTRACT

A method and apparatus for maximizing the number of content titles available within a video on demand system by storing an initial portion of each title on a primary storage device and a remaining portion of each title on a secondary storage device, wherein the secondary storage device is used to provision the primary storage device in response to a subscriber request for a title having an initial portion stored on the primary storage device.

### CROSS REFERENCE

This application claims benefit of United States Provisional Application No. 60/170,138, filed Dec. 10, 1999, which is hereby incorporated by reference in its entirety.

### BACKGROUND OF THE INVENTION

1. Field of the Invention

The present invention relates to an information distribution system such as a video-on-demand (VOD) system. More particularly, the present invention relates to a method and apparatus for efficiently utilizing “on line” and “near line” storage media to provide increased availability of content streams to users.

2. Description of the Background Art

VOD systems providing content encoded according to the various Moving Pictures Experts Group (MPEG) standards are known. For example, a first standard known as MPEG-1 refers to ISO/IEC standards 11172, which is incorporated herein by reference in its entirety. A second standard known as MPEG-2 refers to ISO/IEC standards 13818, which is incorporated herein by reference in its entirety. Additionally, a compressed digital video system is described in the Advanced Television Systems Committee (ATSC) digital television standard document A/53, incorporated herein by reference.

The most important characteristic of a video on demand system is the experience of a user receiving content via that system. That is, a user ideally selects desired content and the system provides the desired content to the user in a timely manner and at a quality level consistent with the user's expectations. Failure to meet the user expectations in terms of image quality, sound quality, system latency or other factors results in a less than satisfying experience to the user.

In the case of a video on demand system utilizing a plurality of servers to provide content to users, it is seen to be desirable to sense anomalous conditions or other errors within a server presently providing content to a user and, upon determination that an error exists, migrating that user to a server not affected by the error condition. More specifically, it is seen to be desirable to provide a method and apparatus for migrating users between information server modules in a manner minimizing disruption of content streams being provided to the user.

### SUMMARY OF THE INVENTION

The disadvantages heretofore associated with the prior art are overcome by the present invention of a method and apparatus for maximizing the number of content titles available within a video on demand system by storing an initial portion of each title on the primary storage device and a remaining portion of each title on a secondary storage device, wherein said secondary storage device is used to provision said primary storage device upon request of said content stream stored on said primary storage device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of an interactive information distribution system;

FIG. 2 depicts a block diagram of an information server suitable for use in the interactive information distribution system of FIG. 1;

FIG. 3 depicts a graphical diagram useful in understanding the present invention;

FIG. 4 depicts a graphical diagram useful in understanding the present invention; and

FIG. 5 depicts a flow diagram of a method according to the present invention and suitable for use in the interactive information distribution system of FIG. 1

To facilitate understanding, identical reference numerals have beer used, where possible, to designate identical elements that are common to the figures.

### DETAILED DESCRIPTION

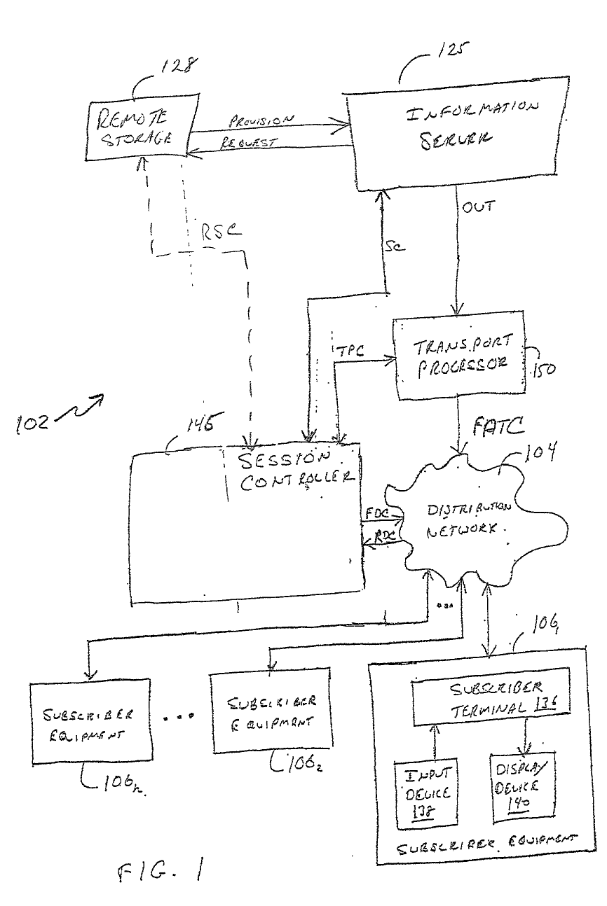

FIG. 1 depicts a high level block diagram of an interactive information distribution system. Specifically, FIG. 1 depicts a high level block diagram of an interactive information distribution system 100 containing the present invention. The system 100 contains service provider equipment 102, a communications network 104 and subscriber equipment 106n, where n is an integer greater than zero.

The service provider equipment 102 comprises an information server 125, a session controller 145, a transport processor 150 and, optionally, a remote storage module 128. Briefly, the session controller 145, in response to a request(s) from subscriber equipment 106, causes the requested content to be retrieved from the information server 125 and provided to the transport processor 150. The transport processor 150 combines or multiplexes the retrieved content to provide an output data stream for the requesting subscriber(s). The output data stream is conditioned for transport to the requested subscriber via a forward application transport channel (FATC) within the distribution network 104.

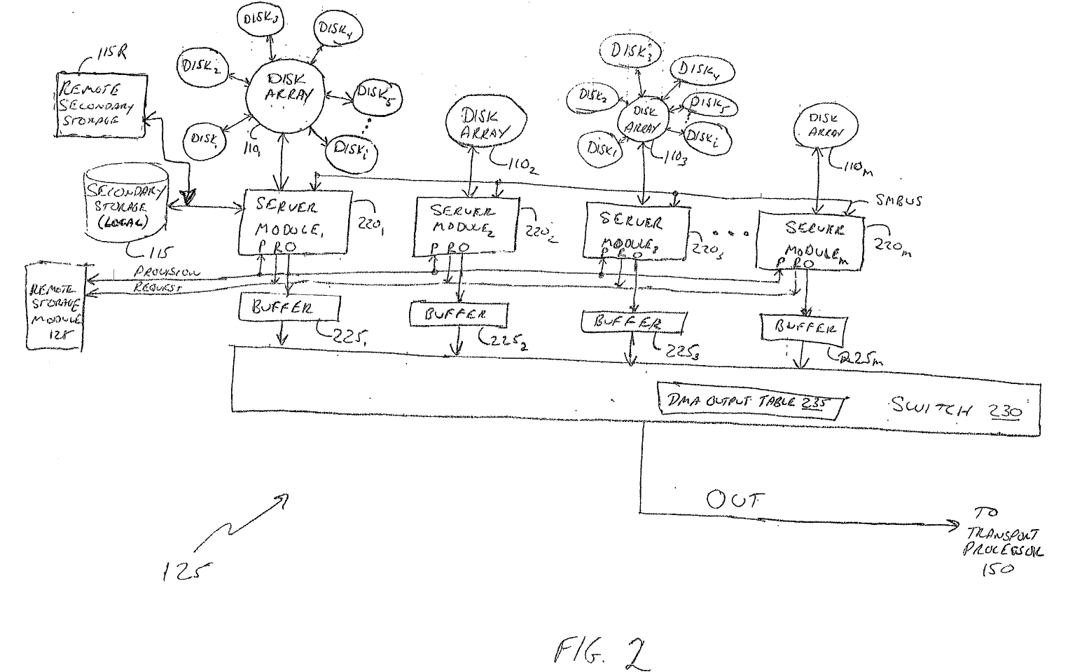

The information server 125 is used to store at least a portion of content such as movies, television programs and other information offerings of the interactive information distribution system 100 of FIG. 1. Additionally, the information server 125 is used to store assets such as bit map imagery, graphic overlay, control scripts and the like. The assets may comprise, for example, navigation assets that are used by a set top terminal to interactively navigate, and select for viewing, the offerings or content available from the service provider equipment 102. The information server 125, in response to a control SC produced by the session controller 145, provides content and/or asset data to the transport processor 150. In the case of the information server 125 storing only a portion of content requested by a user, the information server 125 communicates with a secondary storage module, such as remote storage module 128, to retrieve at least the remaining portion of the requested content. In this manner, the information server 125 may be used to store only a portion of each of a plurality of content streams (such as movies) available to users. This aspect of the system 100 of FIG. 1 will be described in more detail below with respect to FIGS. 2-5. The information server will be described in more detail below with respect to FIG. 2.

The session controller 145 provides session control of the information flowing to and from the information server 125, and may be generally described as a system providing or controlling communications between, for example, a cable system head-end and one or more set top terminals 136 The session controller 145 produces the storage control signal SC for controlling and communicating with the information server 125, and a transport processor control signal TPC for controlling and communicating with the transport processor 150. In response to a user request for particular content, the session controller 145 causes the requested content file and to be streamed from the information server 125 to the transport processor 150. The session controller 145 optionally produces a remote storage control signal RSC for controlling and communicating with the remote storage module 128. Remote storage control signal RSC is used to cause remote storage module 128 to begin the process of retrieving a remaining portion of a content stream requested by a user, where an initial portion of that content stream is stored within a primary storage device in the information server 125. In this manner, the provisioning of the primary server with the requested content may be more rapidly accomplished.

The session controller 145 sends data, such as commands, encryption keys and the like, to set top terminals via a forward data channel (FDC). The session controller 145 receives data, such as information stream requests and session initiation data (set top identification, capability and the like) via a reverse data channel (RDC). The FDC and RDC are supported by the distribution network 104 and comprise relatively low bandwidth data channels, such as one-two megabits per second data channels utilizing QPSK, QAM, or other modulation techniques. The FDC and RDC are also known as “out-of-band” channels, while the relatively high bandwidth forward application transport channel (FATC) is also known as an “in-band” channel. The session controller 145 contains an interface device for sending control information via the forward data channel FDC and receiving control information and request information via the reverse data channel RDC using the so-called “out-of-band” carrier frequencies.

The transport processor 150 accomplishes all of the forward content channel transmission interface requirements of the system 100 of FIG. 1. Specifically, the transport processor 150 is coupled to subscriber equipment via the forward applications transport channel (FATC). That is, the transport processor 150 is capable of providing a plurality of scrambled or unscrambled content and/or asset streams modulated onto various carrier frequencies suitable for use in the distribution network 104. The FATC is supported by the distribution network 104 and comprises a relatively high bandwidth communications channel well suited to carrying video, audio and data such as, for example, multiplexed MPEG-2 transport packets. It should be noted that data normally conveyed to a set top terminal via the FDC may be included in the FATC data stream. The transport processor 150 also contains a modulator for modulating the combined content and asset stream onto one or more carrier frequencies for transmission on the FATC, the so-called “in-band” carrier frequencies.

The distribution network 104 can be any one of a number of conventional broadband communications networks that are available such as a fiber optic network, a telephone network, a cable television network and the like. For example, if the network is a hybrid fiber-coax network, the transmission transport technique used in both forward channels may be modeled after the Moving Pictures Expert Group (MPEG) transport protocol for the transmission of video data streams. In general, the transport mechanism for both of the forward channels that transport information to the set top terminal must be able to carry unidirectional, asynchronous packetized data such as that defined in the MPEG video and audio signal transmission protocol, and the like. There are a number of such transport protocols available.

The subscriber equipment 106 comprises a set top terminal or a set top box 136, a display device 140 (e.g. a conventional television) and a user input device 138 (e.g. a remote control device). Each set top terminal 136 receives the data streams from the FATC, demodulates the received data streams and, in the case of video streams, processes the demodulated video streams for subsequent display on the display device 140. In the case of receiving scrambled data streams, the STT descrambles the received data streams using the descrambling messages DM provided to the STT via the FATC or the FDC. The STT uses the authorization messages AM provided via the FATC or FDC to determine if a descrambling of the received scrambled stream is authorized. In addition, the set top terminal 136 accepts commands from the remote control input device 138 or other input device. These commands are formatted, modulated, and transmitted through the distribution network 104 to the session controller 145. Typically, this transmission is accomplished through the reverse data channel RDC. These commands are preferably transmitted through the same network used to transmit information to the set top terminal. However, the RDC coupling the set top terminal to the provider equipment 102 may be a separate network, e.g. a FATC through a television cable network and an RDC through a telephone network. The telephone network could also support the FDC.

FIG. 2 depicts a block diagram of an information server suitable for use in the interactive information distribution system 100 of FIG. 1. Specifically, the information server 125 of FIG. 2 comprises a plurality of server modules 220₁-220ₘ, where m is an integer (collectively service modules 220). Each of the server modules 220 is coupled to a respective disk array 110 functioning as a primary storage module. Each of the respective disk arrays 110 comprises, illustratively, a plurality of disks, such as optical or magnetic storage disks capable of providing an appropriately high throughput. It will be noted in FIG. 2 that the first disk array 110₁, which is coupled to the first server module (220₁) comprises a plurality of disks denoted as DISK₁ through DISK₁, where i is an integer. Similarly, disk array 110₃, which is coupled to server module 220₃ comprises a plurality of disks denoted as DISK₁ through DISKᵢ. To simplify FIG. 2, disks forming the disk arrays 110₂, 110₄ and 110ₘ of the remaining server modules 2 and 4 through m are not shown.

It will be appreciated by those skilled in the art that each server module 220 may be associated with more than one disk arrays 110. Moreover, the disk arrays 110 coupled to the server modules 220 may comprise high speed disk arrays suitable for providing primary or “on line” storage and/or lower speed disk arrays suitable for providing secondary or “near line” storage. In this context, primary storage media is defined as storage media capable of streaming (i.e., accessing and providing data to the buffer during the appropriate extent deadline) content in real time to a user within the system. By contrast, secondary storage is defined as media that typically does not stream real time content to users. Secondary storage comprises, illustratively, magneto optical disk drives, tape drives, and other media which provide relatively low cost storage of content and/or asset data, though typically at the expense of increased latency. It will be appreciated that while secondary storage is typically defined as non-realtime capable, that consideration is strictly a matter of system architecture selection. Since the cost of mass storage devices is decreasing dramatically while the capability of such devices is increasing dramatically, present mass storage technology is capable of providing inexpensive, realtime content streaming functionality.

Storage devices may be segmented into a plurality of groups; namely, on line, off line, and near line. On line storage units, such as primary storage units comprising disk drive arrays and other high speed storage units are suitable for providing streamed content directly to users. Off line storage devices are most suitable for archival purposes (e.g., tape drives and other sequential access devices). Near line storage devices, such as magneto-optical disks and other relatively slow mass storage devices, are capable of provisioning on line devices in a sufficiently rapid manner (i.e., provisioning a primary device in a timely manner such that a content stream provided to a user is maintained).

For purposes of simplification, it is assumed that the disk arrays 110 of FIG. 2 are primary storage media. Within the system 100 of FIG. 1, such primary storage media typically store at least an initial portion of a core group of the content and/or asset data available from the information provider equipment 102. However, in the case of a user requiring non-primary content, such as an old movie or some other content and/or asset data deemed ill suited for primary storage, the server module 220 supporting that particular user will have to move the desired content from the appropriate secondary storage module (e.g., a tape drive) to the primary storage module (e.g., a disk array). As will be discussed in detail below, the present invention enables the storage of initial portions of a very large subset (or all) of the available content on primary storage media.

As noted in FIG. 2, a local secondary storage module 115 is associated with the first server module 220₁. It will be appreciated by those skilled in the art that the local secondary storage module 115 may be associated with each of the server modules 220 within the information server 125 of FIG. 2. Moreover, each of the server modules 220 may be associated with a plurality of secondary storage modules (not shown) such that the server modules 220 are respectively associated with “shared” and “non-shared” local secondary storage modules.

In one embodiment of the invention, one or more of the server modules 220 of the information server 125 are operably coupled to the remote storage module 128 depicted in FIG. 1. The remote storage module 128 may comprise any high capacity storage module suitable for storing either the remainder portion of content streams or entire content streams. Additionally, remote storage module 128 (as with the local secondary storage modules 115) is used to store the play stream, fast forward stream, rewind stream, associated audio streams, and any other streams related to the content. Alternatively, a remote secondary storage module 115R is depicted as cooperating with the server modules 220 (illustratively, server module 220₁) to provide secondary storage functionality.

It is noted that the remote secondary storage module 115R and/or the remote storage module 128 may be coupled to the server modules 220 via a high speed network such as an optical network, the internet, a satellite network and the like. All that is required is that the appropriate content stream or content stream portion to be served to a user is accessible in a timely manner and that the network communicating the content or content portion from the remote secondary storage 115R or remote storage module 128R includes sufficient bandwidth. It is also noted that the secondary storage devices 115, 115R and the remote storage module 128 may store portions or entireties of content streams.

In one embodiment of the invention, a primary storage device includes only an initial portion of a content stream to be provided to a user. In response to the user selecting the content stream, a secondary storage device is immediately utilized to provision the primary storage device with the remaining portion of the content stream. Thus, the primary storage device is used to store the entirety of a content stream requested by a user, and such provisioning of the primary storage device is effected upon, for example, a user request for the content stream.

In alternate embodiments of the invention, the secondary storage device streams the remaining portion of content to the requesting user while, optionally, provisioning the primary storage device with the remaining portion of the content stream. In this manner, multiple users requesting the same content stream may be satisfied via a single access of the secondary storage device.

In the case where the primary storage device is provisioned by the secondary storage device, the primary storage device may be used to stream the remaining portion of content after such provisioning. In this example, the initial portion of a content stream requested by a user is provided by a primary storage device, a first portion of the remaining portion is then provided by the secondary storage device which also contemporaneously provisions the primary storage device with the remaining portion of the content stream. Upon completion of the provisioning of the primary storage device, the primary storage device is again used to provide the content stream directly to the user. Thus, transitions in servicing the user are made from the primary storage device to the secondary storage device at the end of the stored initial portion of the content, and from the secondary storage device to the primary storage device after provisioning of the primary storage device. Such transition may be effected by migrating users between primary and secondary storage devices/servers.

An information server 125 suitable for use in the present invention is described by Chin et al. in U.S. Pat. No. 5,579,527 and incorporated herein by reference in its entirety. A system for supplying streams to multiple users suitable for use in the present invention is described by Bleidt et al. in U.S. Pat. No. 5,671,377 and incorporated herein by reference in its entirety. It must be noted that while the invention may advantageously utilize a massively parallel storage, retrieval and distribution system, the invention does not require the use of such a system. Rather, the invention is well suited to any storage arrangement in which the user is receiving data from a plurality of server modules storing similar data are migrated between the server modules.

A method and apparatus for minimizing disk drive access time in, e.g., a disk drive array and suitable for use in the present invention is described by Armstrong in commonly assigned U.S. patent application Ser. No. 08/818,172 (Attorney Docket No. 533/11635), filed on Mar. 14, 1997 and incorporated herein by reference in its entirety.

Each server module 220 (within the information server 125) is associated with a respective buffer 225. Each buffer memory is capable of holding at least one service period (i.e., one extent) worth of information retrieved from a disk array 110 via the respective server module 220. Each buffer 225 is coupled to a switch 230.

The switch 230 operates to multiplex the contents of each buffer 225 in a round robin fashion to produce an output stream OUT that is coupled to the transport processor 150 for subsequent transport to the appropriate subscribers 106 via the forward application transport channel (FATC) supported by the distribution network 140. The exemplary embodiment uses a service period of two seconds. Thus, each extent retrieved from a single disk within a disk array 210 comprises two seconds worth of information, illustratively, video information and associated audio information. Thus, in the case of 30 frames per second video, each buffer 225 must hold at least 60 frames of video and any associated audio information. The output stream OUT is modulated by modulation circuitry within the transport processor 150 and transmitted to the appropriate subscribers.

In one embodiment of the invention, each of the output buffers 225 supporting the server modules 220 comprise respective portions of a common memory module. That is, each of the server modules 220 stores data to a respective portion of a common memory module. In this embodiment of the invention, the switch 230 utilizes a direct memory access (DMA) output link table 235 to access the appropriate portions of the common buffer memory to retrieve the contents of each of the output buffers 225.

Each server module 220 is capable of providing information to a plurality of users 106. Thus, each buffer 225 associated with a server module 220 is capable of holding at least one extent of data for each of the plurality of subscribers 106 serviced by that server module 220. For example, if the first server module (220₁) is capable of serving 100 subscribers, then the buffer 225₁ associated with the first server module 220₁ must be capable of holding at least 200 seconds worth of information, illustratively video information and any associated audio information.

Under normal operating circumstances, each server module 220 retrieves information from its respective disk array (primary storage) for each subscriber 106 supported, and transfers the retrieved information to the respective buffer (or buffer region) 225. The switch 230 accesses each buffer 225 in a round robin fashion to produce an output stream OUT comprising the multiplexed contents of each of the buffers 225₁ to 225ₘ. In the case of only a portion of each available information stream being stored in a respective disk array, the stored portion is transferred to the respective buffer 220 while at the same time the remaining portion is retrieved from a secondary storage unit, such as local secondary storage module 115 or remote secondary storage module 128.

In the case of a server module failure, a primary or secondary storage failure such as a disk array failure, a buffer failure, or some other event affecting the flow of information to subscribers via one of the server modules 220, the users on the affected server module 220 is migrated to another server module. Since the information server 125 comprises a plurality of server modules 220, the loss of one or more server modules 220 may be compensated for by migrating some or all of the users from the damaged server module(s) to the remaining, functional server modules. In this manner, component failures within the information server 125 will result in a degradation of information server performance that, ideally, will not adversely impact the experience of users receiving content streams within the information distribution system 100 of FIG. 1.

Advantageously, a user may also be migrated to another server module if the other server module includes, in a respective primary storage module, the entire content stream requested by that user. Specifically, assume that a first server module is servicing a user that has requested a particular content stream. If the particular content stream is only partially stored in the primary storage associated with the first server module, then the remaining portion of the requested content must be retrieved from a secondary storage module. However, if another server module includes the entirety of the requested content within its primary storage, then the user may be migrated to the second server module. In this manner, the user content request may be satisfied without resorting to secondary storage access. Apparatus and method for effecting a user migration between server modules is described in more detail in commonly assigned U.S. patent application Ser. No. ______, filed on (Attorney Docket No. 533/241), which is incorporated herein by reference in its entirety.

To accomplish such migration of users between server modules 220, and to determine if requested content is available on other server modules 220, the server modules 220 communicate with each other via a service module bus SMBUS to determine if such a migration is possible or useful.

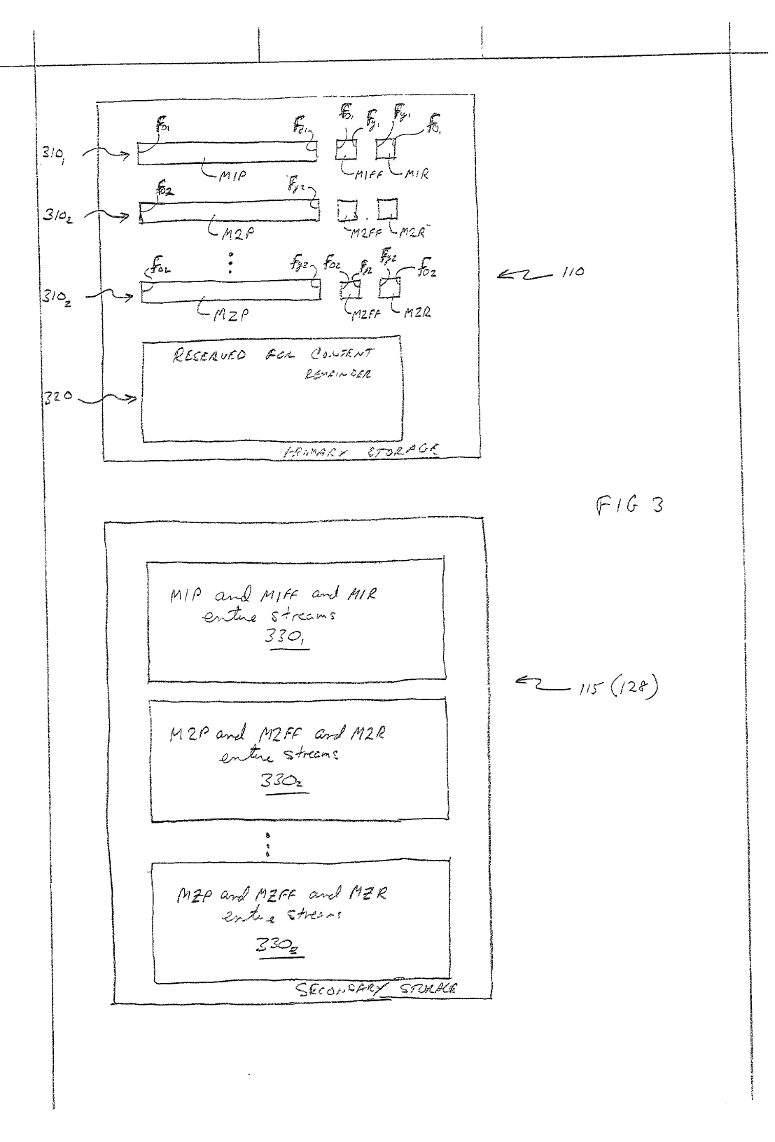

FIG. 3 depicts a graphical diagram useful in understanding the present invention. Specifically, FIG. 3 depicts a graphical representation of content stored by a primary storage module and a secondary storage module according to one aspect of the invention. Specifically, a primary storage module, such as the disk array 110, is used to store only a portion of each of a plurality of content streams. Each content stream comprises at least a play track and, optionally, a fast forward track and rewind track. A play track comprises a normal speed track. A fast forward track comprises a temporally decimated version of a play track which, when played by the subscriber equipment 106, results in a fast forward or “special play” presentation of the content on the user's presentation device. A rewind track comprises a temporally decimated version of a play track which has been reversed in order (e.g., a frame-reversed FF track) such that, when played by a user, results in a rewind or “reverse play” presentation of the content. It should be noted that fast forward and rewind tracks may be created to impart any desired increase in apparent play rate. However, in keeping with the traditional fast forward/rewind rates of standard analog video cassette recorders (VCRs), the exemplary embodiment uses fast forward rewind tracks having a presentation rate of between seven and nine times the presentation rate of the play track.

Referring to the primary storage 110 depicted in FIG. 3, a plurality of content streams M1-MZ (310₁-310z) are depicted as being represented by respective initial play (P), fast forward (FF) and rewind (R) portions. Each of the respective initial portions of the content streams M1-MZ (310₁-310_{z}) is sufficient to provide an initial presentation of, for example, 20 minutes to a requesting user. Additionally, a portion 320 of primary storage is reserved for the remainder of content being streamed to a requesting user. Specifically, a reserved portion 320 of primary storage is used to store the remainder portion of content stream(s) requested by user(s) within the system.

Referring to the secondary storage 115/128 depicted in FIG. 3, a plurality of at least remaining portions of the content streams M1-MZ (330₁-330_{z}) are depicted as being stored therein. For example, in the case of a user requesting a first content stream M1 (310₁), the play track of the first content stream M1P is streamed to the requesting user. The remaining portion of the first content stream M1 is retrieved from the secondary storage module such as local secondary storage module 115 or remote secondary storage module 128 and stored in the reserved portion 320 of the primary storage module 110 for subsequent streaming to the requesting user. It is important to store at least some of the remaining portion of the requested content in reserved portion 320 prior to the presentation of the terminating image frame F_{Y1}. In this manner, the stream provided to the user may be changed from the initial content stream 310 to a remaining content stream 320 in a relatively seamless manner.

Referring to FIG. 3, a primary storage module (illustratively a disk array 110) is depicted as storing respective initial portions of each of a plurality of content streams (denoted as M1 through MZ while a secondary storage module (illustratively a magneto-optical or tape drive) is depicted as storing respective remaining portions of the plurality of content streams). While the following discussion is primarily directed to a first content stream M1, it will be understood that the discussion is equally applicable to the other content streams M2-MZ.

Specifically, a portion of a first content stream M1 is stored as a play track portion M1P, a fast forward track portion M1FF and a rewind track portion M1R. The play track portion M1P comprises all frames between a first image frame F₀₁ and a terminating image frame F_{Y1}. The first image frame F₀₁ comprises the first image frame of the content stream M1. The terminating image frame F_{Y1} comprises the last image frame of the initial portion of the content stream M1 stored in the primary storage device. For purposes of this discussion, it will be assumed that a 20 minute portion of each content stream M1-MZ is stored in the primary storage device. Therefore, assuming a frame rate of 30 frames per second, the terminating image frame F_{Y1} is approximately the 36,000^{th} frame of the first content stream M1.

The fast forward track portion M1FF of the content stream M1 comprises that portion of the fast forward track including the first image frame F₀₁ and the terminating image frame F_{Y1}. Similarly, the portion of the rewind track M1R of the content stream M1 comprises that portion of the rewind track including the terminating image frame F_{Y1} and the first image frame F₀₁. In the embodiment of the invention depicted in FIG. 3, the rewind track M1R of the content stream M1 comprises, essentially, a reversed frame order version of the fast forward track M1FF of the content stream M1. However, as will be discussed in more detail below, the fast forward and rewind tracks do not need to be of the same length, nor must they be inclusive of the same content. However, to simply the discussion of the present invention, the fast forward and rewind tracks are made symmetrical as shown in FIG. 3.

Thus, an initial (e.g., 20 minutes) portion of a first content stream M1 is represented by those portions of a corresponding play track M1P, fast forward track M1FF and rewind track M1R bounded by an initial image frame F₀₁ and a terminating image frame F_{Y1}. Though not shown, it will be appreciated by those skilled in the art that at least the audio portion associated with the play track M1P is also stored in the primary storage device and presented with the play track. In addition to the audio portion, meta-data and other auxiliary data related to the content stream may also be stored on the primary storage device for utilization within the presentation of the content by a user.

In one embodiment of the invention, the fast forward track M1FF and rewind track M1R associated with the content stream do not include all of the corresponding frames associated with the entire play track M1P. Specifically, since the major use for a fast forward track, at least at the beginning of a content stream, is fast forwarding through introductory materials, trailers, credits and other content other than the feature presentation of the content stream, such non-feature presentation content is included within the fast forward track M1FF. In this manner, the storage of fast forward (and, optionally, rewind) track information associated with feature presentation is avoided.

Referring to FIG. 3, it is noted that the secondary storage module is depicted as including the entire play, fast forward, and rewind tracks for each of a plurality of content streams denoted as M1-MZ (330₁-330_{z}). Specifically, the entire play track M1P, fast forward track M1FF and rewind track M1R of the entire content stream M1 is depicted as being stored in a memory region 330₁ of the secondary storage module. Similarly, the entire play track, fast forward track and rewind track of content streams 2-Z are depicted as being stored in respective regions 330₂-330. However, in another embodiment of the invention, only the remaining portion of the content stream is stored in the secondary storage module. That is, the primary storage module 110 is used to store only the initial portion, while the secondary storage module is used to store only he remaining.

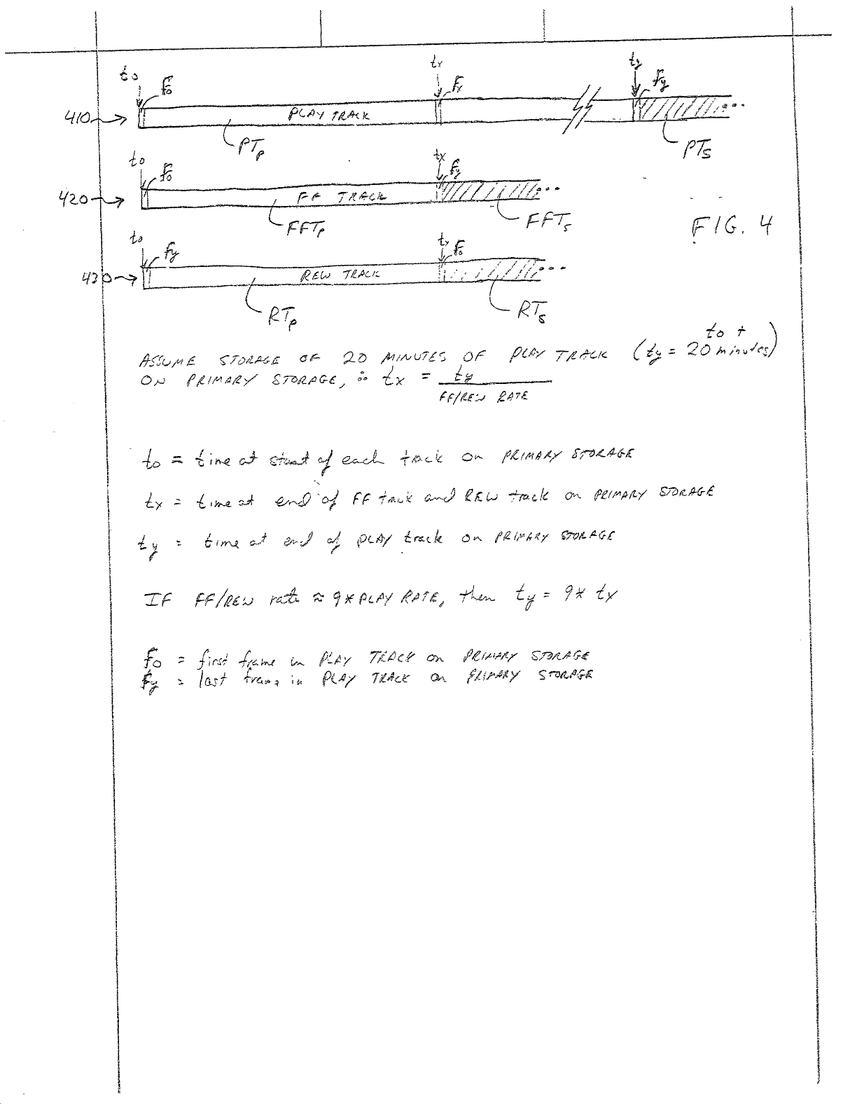

FIG. 4 depicts a graphical diagram useful in understanding the present invention. Specifically, FIG. 4 depicts a graphical representation of the play track 410, fast forward track 420 and rewind track 430 of a content stream.

A first or initial portion PTₚ of the play track is stored on a primary storage module, while at least a remaining portion PTₛ of the play track 410 is stored on a secondary storage module. A first or initial portion FFT_{P} of the fast forward track 420 is stored on the primary storage module, while a remaining portion FFT_{S} of the fast forward track is stored on the secondary storage module. A first or initial portion RT_{P} of the rewind track 430 is stored on a primary storage module, while a remaining portion RT_{S} of the rewind track 430 is stored on a secondary storage module.

It is assumed that the portion PT_{P} of the play track 410 stored on the primary storage module comprises a 20 minute play track. Referring to FIG. 4, the portion PT_{P} of the play track stored on the primary storage module begins at a time to with an initial image frame F₀, and terminates at a time t_{Y} with a terminating image frame F_{Y}. Each of the fast forward track portion FFT_{P} and rewind track portion RT_{P} begin at time to and terminate at a time t_{X}. The fast forward track portion FFT_{P} begins with an image frame F₀ and terminates with an image frame F_{Y}. By contrast, the rewind track portion RT_{P} begins with an image frame F_{Y} and terminates at the image frame F₀.

The time t₀ is the time at the start of each track stored in the primary storage module. The time t_{Y} is equal to the time at which the play track portion PT_{P} ends. The time t_{X} is the time at which the fast forward track portion FFT_{P} and rewind track portion RT_{P} ends. The time t_{X} is related to t_{Y} by the fast forward/rewind rate of the fast forward track 420 and rewind track 430. For example, if the FF/REW rate is equal to approximately nine times the play rate, then t_{Y} is equal to approximately nine times t_{X}. Therefore, if t_{Y} is determined to be 20 minutes, then t_{X} is equal to approximately 2.22 minutes.

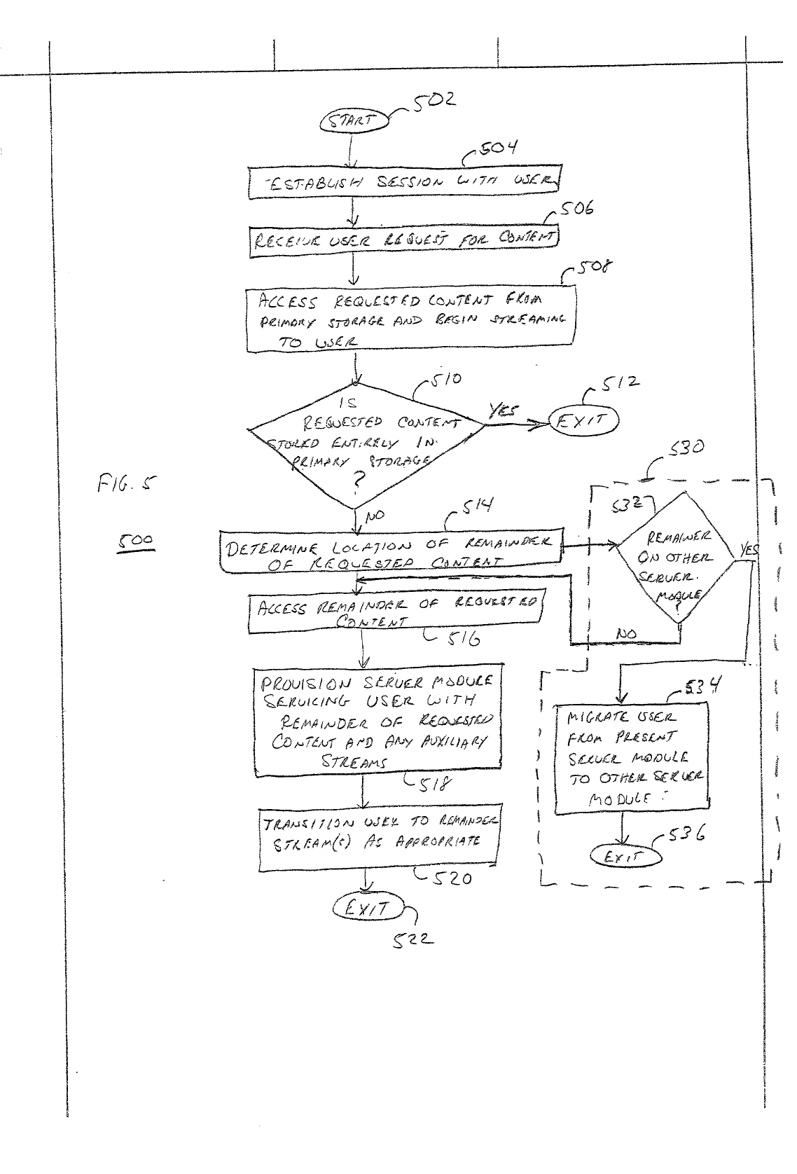

FIG. 5 depicts a flow diagram of a method according to the present invention and suitable for use in the system of FIG. 1. Specifically, FIG. 5 depicts a flow diagram of a method 500 for satisfying user requests for content within the context of a system in which content is only partially stored in a primary storage module (as described above with respect to FIGS. 2, 3 and 4).

The method 500 is entered at step 502 and proceeds to step 504, where a session with a user is established. That is, the server controller 145 sets up the physical channel and logical channel for providing content in the user via the FATC. In addition, Navigation assets and other data are provided to the user. The method 500 then proceeds to step 506, where a user request for content is received, and to step 508.

At step 508 the requested content is accessed from the primary storage module and is streamed to the requesting user. That is, at step 508 the portion of the requested content stored in the primary storage module associated with the server module servicing the user is accessed and coupled to the transport processor 150. The transport processor 150 begins providing the content to the user via the forward applications transport channel (FATC) on the physical and local channel defined by the session controller 145 and communicated to the requesting user during session establishment at step 504. The method 500 then proceeds to step 510.

At step 510 a query is made as to whether the requested content is stored entirely in primary storage. That is, a query is made as to whether the particular server module 220 providing content to the requesting user is associated with a primary storage module (such as disk array 110) that includes the requested content and any auxiliary streams (e.g., fast forward and rewind streams) in their entirety. If the query at step 510 is answered affirmatively, then the method proceeds to step 512 where it is exited. In this case, the content is retrieved from primary storage in the normal manner and provided to the requesting user. If the query at step 510 is answered negatively, then the method 500 proceeds to step 514.

At step 514 the location of the remainder of the requested content is determined. That is, at step 514 it is determined whether the remaining portion of the content (play, fast forward, rewind, audio and other tracks) associated with the requested content is stored on a local secondary storage device 115 or the remote secondary storage device 128. The method 500 then proceeds to 516.

At step 516 the remainder of the requested content is accessed from the secondary storage device determined in step 514. The method 500 then proceeds to step 518, where the server module 220 servicing the requesting user is provisioned with the remainder of the requested content and any auxiliary streams. That is, at step 518 the remaining portion of the requested content is stored in a primary storage device associated with the server module servicing the requesting user.

It should be noted that, as previously discussed, a secondary storage device is (typically) unable to provide real time streaming of content to a user, while a primary storage device is capable of providing real time streaming of content to a user. Thus, it is likely that the newly provisioned content on the primary storage device will begin streaming to the requesting user prior to the conclusion of the provisioning process.

Most important is that the user's experience is not significantly degraded or interrupted. Thus, as long as the secondary storage unit (115 or 128) provisions the primary storage unit (display 110) at a sufficiently high rate such that the transport processor 150 is able to continuously provide play, fast forward, rewind and other tracks to the user, then the system is working effectively. The method 500 then proceeds to step 520.

At step 520 the requesting user is transitioned to the newly provisioned remainder stream(s) as appropriate. That is, at step 520 a transition is made in the content stream supplied to the requesting user from the initial content stored on the primary storage device to the remaining content that has been provisioned onto the primary storage device. In the case of a second primary storage device including the requested content, the first primary storage device is not provisioned. Rather, the user stream is retrieved from the second primary storage device.

With the above-described method 500, the user receives a requested content stream without any visual or aural artifacts, while the provider 102 efficiently utilizes primary storage in a manner making a large number of titles available to each user. Such efficient storage utilization helps drive down system costs and improve system reliability. The method 500 then proceeds to step 522 where it is exited.

Optionally, after determining the location of the remainder of the content requested by the user at step 514, the above method 500 proceeds to step 530. At step 530 a determination is made (step 532) as to whether the remaining content is located on a primary storage module associated with another server module 220 within the information server 125. That is, at step 532 a determination is made as to whether another server module has associated with it a primary storage device including the content requested by the user. If the query at step 532 is answered negatively, then the method 500 proceeds to step 516. If the query at step 532 is answered affirmatively, then the method 500 proceeds to step 534.

At step 534 the user is migrated from the present server module to the other server module. That is, since another server module includes, in a respective primary storage means, the content requested by the user, that requesting user is migrated over to the other circuit module. Apparatus and method for effecting this migration between server modules is described in more detail in commonly assigned U.S. patent application Ser. No. ______, filed on ______ which is incorporated herein by reference in its entirety.

After migrating the requesting user from the present server module to the server module including the requested content stored in the respective primary storage means, the method 500 proceeds to step 536 where it is exited.

In the exemplary embodiments of the invention discussed above, the illustrative portion of the play track stored within the primary storage is approximately 20 minutes. The 20 minute storage amount is determined with respect to the speed of the secondary storage devices and the possible use of a fast forward by a user to quickly traverse the entire initial content portion. For example, in the interactive information distribution system 100 of FIG. 1, a user requesting a content stream will begin to receive the content stream from the primary storage. If the user immediately depresses a “fast forward” key on an input device 138, then the set top terminal 136 associated with the user selects from the FATC, the fast forward stream corresponding to the presently received content stream. Thus, a user may rapidly traverse the entire portion of content stored in the primary storage. In the case of a fast forward stream operating at nine times the frame rate of the play stream, a user will be able to traverse the entire 20 minutes of play track in only 2.22 minutes. Therefore, it is necessary that the remaining portion of the content be provided to the primary storage or, alternatively, the user be migrated to a server module including the requested content, prior to 2.22 minutes after beginning presentation of the requested content stream. While not the normal or likely user action, a user who has already seen most of the requested content may simply fast forward to that portion of the content which has not previously been viewed. Thus, it is important to insure that the provisioning of primary storage or migration of user be accomplished in a manner that “stays ahead” of the fast forward or play track demands put upon the system by the user. For example, in the case of a relatively slow secondary storage device, such as a sequentially accessed magnetic tape device in which content may be stored toward the middle or even end of a tape, it may be necessary to increase the size of the initial portion of the content stream stored on the primary storage device. Thus, the primary storage may be used to store anywhere from five minutes to 40 minutes of content, based upon the speed of secondary storage or other determination directed toward assuring a continued, uninterrupted stream of content to a requesting user. The amount of initial content storage is adapted to the system's storage capabilities (i.e., speed, access time, primary and secondary storage mix and the like) and to the acceptable acceptable probabilistic risk level of dropping a stream (i.e., allow only partial fast forward within the initial content and other limitations).

The portion of content rewind track stored in the primary storage must also be adapted to the ability of the system. Specifically, in the case of a user fast forwarding through the initial portion of content stored in the primary storage, that user may decide to rewind at some point. It is necessary to provide a rewind stream in which the user may move from a fast forward (or play) track to the rewind track. Thus, it is desirable to include a rewind track including those frames within the fast forward track.

It is noted that the play track, fast forward track and rewind tracks are all provided to the requesting user based upon user interaction. Each of these tracks is indexed in a manner facilitating transitioning between tracks such that the fast forward, rewind and play paradigms known to users from the analog video cassette recorder (VCR) world are maintained.

The above-described invention advantageously leverages the value of primary storage by using secondary storage to store portions of content likely to be not immediately required to satisfy user requests. Therefore, in a system in which thousands of titles, such as movies, are available, the above-described invention allows immediate user access to all of these titles. By contrast, previous systems stored entire content streams on a primary storage device such that only a small portion (e.g., 400 titles) of the available titles were immediately available. Users requesting content not within the primary storage had to wait until that content was retrieved from secondary storage and used to provision a primary storage device. Thus, the above-described invention reduces average latency experienced by users.

Although various embodiments which incorporate the teachings of the present invention have been shown and described in detail herein, those skilled in the art can readily devise many other varied embodiments that still incorporate these teachings.

What is claimed is:

1. Apparatus, comprising:
a primary storage module, for storing an initial portion of each of a plurality of titles;
a secondary storage module, for storing at least a remaining portion of at least one of said plurality of titles; and
a controller, for processing user requests and causing said primary storage module to begin providing an output stream including an initial portion of a requested title;
said secondary storage module provisioning said primary storage module with a remaining portion of said requested title such that said output stream includes said initial portion and said remaining portion of said requested title.

2. The apparatus of claim 1, wherein said primary storage module comprises a disk drive array and said secondary storage module comprises at least one of a magneto-optical drive and a magnetic tape drive.

3. The apparatus of claim 1, wherein said primary storage module comprises a plurality of server modules, each of said server modules having associated with it a respective disk drive array, each of said server modules being capable of servicing a plurality of users.

4. The apparatus of claim 3, further comprising:
a switch, for multiplexing the respective output streams of said server modules to form therefrom a multiplexed output stream.

5. The apparatus of claim 4, wherein each of said server modules has associated with it a respective output buffer capable of storing at least one service period of said respective server module output stream.

6. The apparatus of claim 1, further comprising:
a transport processor, for receiving an output stream from said primary storage module and causing said output stream to be transported to at least one requesting user via a distribution network.

7. The apparatus of claim 1, further comprising:
a plurality of server modules, each of said server modules being associated a respective disk array, wherein:
a server module for storing at least an initial portion of a title operates as a primary storage module with respect to that title, and a server module storing a remaining portion of said title operates as a secondary storage module with respect to that title.

8. The apparatus of claim 7, wherein a first server module operating as a primary storage module with respect to a requested title is provisioned by a second server module operating as a secondary storage module for said requested title.

9. The apparatus of claim 7, further comprising:
a switch, coupled to each of said server modules via a buffer, for multiplexing the output streams of each of said server modules to produce therefrom a multiplexed output stream for subsequent transport.

10. The apparatus of claim 9, further comprising a transport processor, for adapting the multiplexed output stream primary storage switch for transporting requested titles to requesting users via a forward application transport channel (FATC).

11. The apparatus of claim 9, wherein each of said respective server module buffers comprises a respective portion of a common memory module, said switch further comprising a direct memory access (DMA) output table for identifying the appropriate portions of the common memory module including data to be retrieved and provided to said switch output.

12. The apparatus of claim 8, wherein:
each of said server modules is capable of servicing a plurality of users, and an overutilized server module is capable of migrating serviced users to an underutilized server module.

13. Apparatus, comprising:
an information server, for storing at least an initial portion of each of a plurality of titles;
a controller, for processing user requests and causing said information server to begin providing an output stream including at least said initial portion of a requested title to a transport processor; and
a remote storage module, for storing at least a remaining portion of at least one of said plurality of titles, said remote storage module providing as necessary to said information server said remaining portion of requested titles.

14. The apparatus of claim 13, wherein said transport processor adapts said information server output stream to a format suitable for use in a forward application transport channel (FATC) delivering requested titles to users.

15. In an interactive information distribution system including provider equipment and subscriber equipment, said provider equipment communicating with said subscriber equipment via a network, provider apparatus comprising:
a controller, for interacting with subscribers to receive title requests;
an information server, for storing titles and providing an output stream including titles requested by said subscribers; and
a transport processor, for transport encoding said output stream for subsequent distribution via said network;
said information server comprising a plurality of server modules, each of said server modules operating as at least one of a primary storage module and a secondary storage module, wherein a primary storage module store at least initial portions of a title and responsively provide said output stream including said initial portion of said title, and said secondary storage module stores at least a remaining portion of said title and provisions said primary storage module with said remaining portion of said title.

16. The apparatus of claim 15, wherein each server module is operably coupled to at least one primary storage device for storing at least an initial portion of each of a plurality of available content streams, and at least one secondary storage device for storing the remaining portion of at least one of said content streams.

17. The apparatus of claim 16, wherein said primary storage device comprises a disk drive array and said secondary storage device comprises at least one of a magneto-optical drive and a magnetic tape drive.

18. The apparatus of claim 15, further comprising:
a switch, coupled to each of said server modules via a respective buffer, for multiplexing the respective output streams of said server modules to form therefrom a multiplexed output stream.

19. The apparatus of claim 18, wherein each of said respective server module buffers comprises a respective portion of a common memory module, said switch further comprising a direct memory access (DMA) output table for identifying the appropriate portions of the common memory module to be retrieved and provided to said switch output.

20. The apparatus of claim 19, wherein each respective buffer is capable of storing at least one service period of said respective output stream.

21. A method, comprising the steps of:
accessing a content stream including at least an initial portion of a requested title, said initial portion being stored in a primary storage device;
initiating the streaming of said accessed content stream to a requesting user;
determining a location of a content stream including a remaining portion of said requested title; and
provisioning said primary storage device with said content stream including said remaining portion of said requested title.

22. The method of claim 21, wherein said content stream including said remaining portion of said requested title is stored on a secondary storage device.

23. The method of claim 22, wherein said primary storage device comprises one of a plurality of server modules having stored therein said content stream including said initial portion of said requested title; and
said secondary storage device comprises one of a plurality of server modules having stored therein said content stream including said remaining portion of said requested title.

24. The method of claim 23, wherein each of said server modules functions as at least one of a primary storage device and a secondary storage device, wherein a server module storing a content stream including an initial portion of a title operates as a primary storage device with respect to that title, and a server module storing a content stream including a remaining portion of said title operates as a secondary storage device with respect to that title.

25. The method of claim 23, wherein each of said server modules is capable of servicing a plurality of users, said method further comprising:
determining a utilization level for each server module; and
migrating at least one user from an overutilized server module to a non-overutilized server module.

26. Method of claim 21, further comprising:
migrating a user receiving said content stream from said primary storage device to said secondary storage device where said secondary storage device comprises a server module.

27. Method of claim 21, further comprising:
migrating a user receiving said content stream from said primary storage device to said secondary storage device when a user load balancing among storage devices is appropriate.
